(19) United States
(12) Patent Application Publication
(10) Pub. No.: US 2015/0086183 A1
(43) Pub. Date: Mar. 26, 2015

(54) LINEAGE OF USER GENERATED CONTENT

(71) Applicant: Microsoft Corporation, Redmond, WA (US)

(72) Inventors: Henry C. Sterchi, Redmond, WA (US); Bradley Rebh, Bothell, WA (US); Robert Poerschke, Redmond, WA (US); Scott Fintel, Kirkland, WA (US); Jason Major, Redmond, WA (US); Soren Hannibal Nielsen, Kirkland, WA (US); James S. Yarrow, Redmond, WA (US); Ellery Charlson, Kirkland, WA (US); Matthew D. Kerr, Bellevue, WA (US)

(73) Assignee: Microsoft Corporation, Redmond, WA (US)

(21) Appl. No.: 14/038,505

(22) Filed: Sep. 26, 2013

(51) Int. Cl. G11B 27/34; G11B 27/034; G11B 27/032

(52) U.S. Cl. CPC G11B 27/34; G11B 27/032; G11B 27/034
USPC 386/286

(57) ABSTRACT

A system and method are disclosed where users are rewarded and acknowledged for generating content and for remixing (modifying) the user generated content of others. In examples, the content may be levels of a virtual world for a gaming system.

### BACKGROUND

Gaming systems have evolved from those which provided an isolated gaming experience to networked systems providing a rich, interactive experience which may be shared in real time between friends and other gamers. With Microsoft's Xbox® video game system and Xbox Live® online game service, users can now easily communicate with each other to share gaming and other media experiences. Further recent developments have involved the integration of a natural user interface (NUI) into a gaming system, and the distribution of a user experience among multiple, interactive devices and screens. These developments have opened a host of new possibilities for users to build and share virtual environments and experiences.

### SUMMARY

The present technology in general relates to a system and method where users are rewarded for generating content, and for modifying the user generated content of others. Once a user generates content, such as for example a virtual gaming environment, that environment may be uploaded and saved. Thereafter, other users may download and “remix” the original content by adding to or altering the original content. The remix version is saved and assigned an identifier linking it to the original content. Further remixes of the content may be performed by additional users, to create a tree-structure starting with the content creator and branching out to various remixes. When user generated content is remixed, the content creator and earlier “parent” remixers may be earn virtual credits. The latest remixer may also earn virtual credit, depending on the modifications made to the content. Users may view the family tree of a piece content, including the content creator and subsequent branches of remixes.

In one example, the present technology relates to a method for tracking modifications to user generated content, comprising: (a) storing original user generated content, the original user generated content generated with a computing device executing a content generation software application; (b) storing a first identifier associated with the original user generated content; (c) providing access to the original user generated content so as to allow remixing of the original user generated content; (d) storing a remix of the original user generated content, the remix generated with a computing device executing a content generation software application; (e) storing a second identifier associated with the remix; and (f) linking the first and second identifiers to enable identification of the remix while the original user generated content is accessed, and to enable identification of the original user generated content while the remix is accessed.

In another example, the present technology relates to a computer readable media for programming a processor to perform a method for tracking modifications to user generated content, comprising: (a) storing original user generated content, the original user generated content generated with a computing device executing a content generation software application; (b) storing a first identifier associated with the original user generated content; (c) providing access to the original user generated content so as to allow remixing of the original user generated content; (d) storing a remix of the original user generated content, the remix generated with a computing device executing a content generation software application; (e) storing a second identifier associated with the remix; (f) rewarding a creator of the remix for modifying the original user generated content; and (g) rewarding a creator of the original user generated content upon storing the remix of the user generated content.

In a further example, the present technology relates to a system for tracking modifications to a level of a virtual fantasy environment, comprising: a content generation software application for generating the level and generating one or more remixes of the level and other remixes; one or more natural user interfaces for interpreting audible and physical gestures as input to the content generation software application to generate the level and the one or more remixes of the level and other remixes; a central service for storing and publishing the level and the one or more remixes of the level and other remixes; and a lineage and award engine for linking the level and one or more remixes of the level and other remixes to allow identification of a lineage of remixes that were made from the level and other remixes, and for awarding creators of content whose content gets remixed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates example embodiments of a target recognition, analysis, and tracking system with a user playing a game.

FIG. 2 illustrates an example embodiment of a capture device that may be used in a target recognition, analysis, and tracking system.

FIG. 3A illustrates an example embodiment of a computing environment that may be used to interpret one or more gestures in a target recognition, analysis, and tracking system.

FIG. 3B illustrates another example embodiment of a computing environment that may be used to interpret one or more gestures in a target recognition, analysis, and tracking system.

FIG. 4 a block diagram of a system for implementing embodiments of the present technology.

FIG. 5 is a flowchart for implementing embodiments of the present technology.

FIG. 6 is an example of a tree structure of remixes which can be generated from an original user generated content.

FIG. 7 is an example of a lineage table in accordance with embodiments of the present technology.

FIG. 8 is an example of a tree structure of remixes which can be generated from an original user generated content, and an upstream and downstream lineage of a remix that is being viewed.

FIG. 9 is an upstream and downstream lineage table from a remix being viewed.

FIG. 10 is a graphical illustration of an upstream and downstream lineage of a remix that is being viewed.

FIG. 11 is a block diagram showing a gesture recognition engine for determining whether pose information matches a stored gesture.

FIG. 12 is a flowchart showing the operation of the gesture recognition engine.

### DETAILED DESCRIPTION

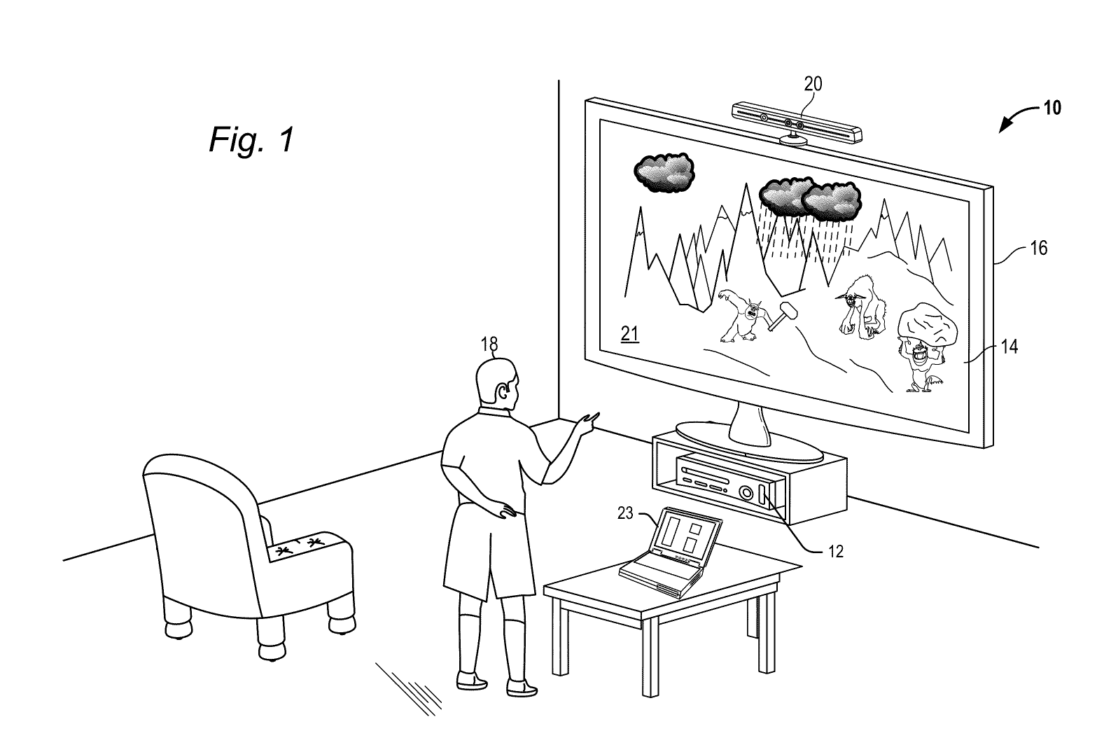

Embodiments of the present technology will now be described with reference to FIGS. 1-12, which in general relate to a system and method where users are rewarded and acknowledged for generating content and for remixing (modifying) the user generated content of others. In one example, the content may be virtual gaming worlds, created with a software platform referred to as Project Spark from Microsoft of Redmond, Wash., described below. However, it is understood that the present technology for rewarding and acknowledging users for creating and remixing user generated content may be used with a wide variety of other content generation software applications.

In one example, the content generation software application, such as the Project Spark software platform, allows users to build, share and remix virtual fantasy environments, referred herein as levels. A user may start for example with a flat, featureless graphic on a display. Thereafter, a user may manipulate and alter voxels via a user interface and software tools to sculpt and paint a virtual three-dimensional level including rich graphics of mountains, rivers, canyons and a wide variety of other topographies and environments. Once the shape of the level is set, users are able to cover the topography with textures, such as desert, arctic, woodland or other terrains. Users may create trees, grass, vertical rock faces and other appearances. The software tool for sculpting, painting and texturing a level is referred to herein as an artist tool.

A further set of software tools may allow users to create and place a variety of props, including virtual animate objects such as people, animals and monsters, and virtual inanimate objects such as houses, rocks, weapons, etc. Any of a wide variety of other props may be created and placed in the level. The software tool for creating and placing props is referred to herein as a designer tool.

A further set of software tools may allow users to give life and purpose to the level. That is, the tool allows users to program behaviors and capabilities into animate and inanimate virtual objects, and to manage interactions and battles between virtual characters and objects. This tool also allows users to create game types, objectives and metrics. The software tool for giving life and purpose to a level is referred to herein as a programmer tool.

It is understood that the above is a brief summary of possibilities for users to create levels using the content generation software application. Users can quickly create levels and games, or can spend long periods of time creating intricately detailed levels and games. Moreover, it is understood that the above-described classifications of level features as being created by artist tools, designer tools or programmer tools is by way of example only, and one or more level creation features may be classified differently in further embodiments.

Once a level is created, a user may upload and save that level to a central server, described hereinafter. It is a feature of the present technology to encourage sharing of user generated levels, not just in game playing and experiencing those levels, but in remixing those levels to create new levels with new graphics, features, experiences and possibilities. Remixing refers to a user making one or more changes to an existing level and uploading that as a new level. In the past, user generated content (UGC) was typically locked for editing once created. The present technology encourages the opposite. It encourages users to remix the UGC of others to create new levels by rewarding and acknowledging both the user that generated the original content and the user(s) that remix the original content. A user may remix content from the content originator, or a user may remix content that has been remixed one or more times already. These aspects of the present technology are explained hereinafter.

User generated levels may be created and uploaded by wide variety of user interfaces and computing devices. One embodiment, explained below, uses a natural user interface (NUI) and/or the distribution of a user experience among multiple, interactive devices and screens to create and upload levels. One example of a NUI system which may be used to generate levels is the Kinect motion sensing input system by Microsoft for the Xbox 360 video game console and Windows PCs. One example of a system for distributing a user experience among multiple interactive devices and screens is the Xbox SmartGlass software application by Microsoft. This application interconnects a variety of computing devices to, for example, allow laptops, tablets and mobile computing devices to provide additional screens, remote control and other peripheral services to the Xbox console or Windows PC. Examples of these systems are described below. However, as noted, other systems may be used in addition to or instead of these systems to reward and acknowledge the creation, sharing and remixing of user generated levels according to embodiments of the present technology.

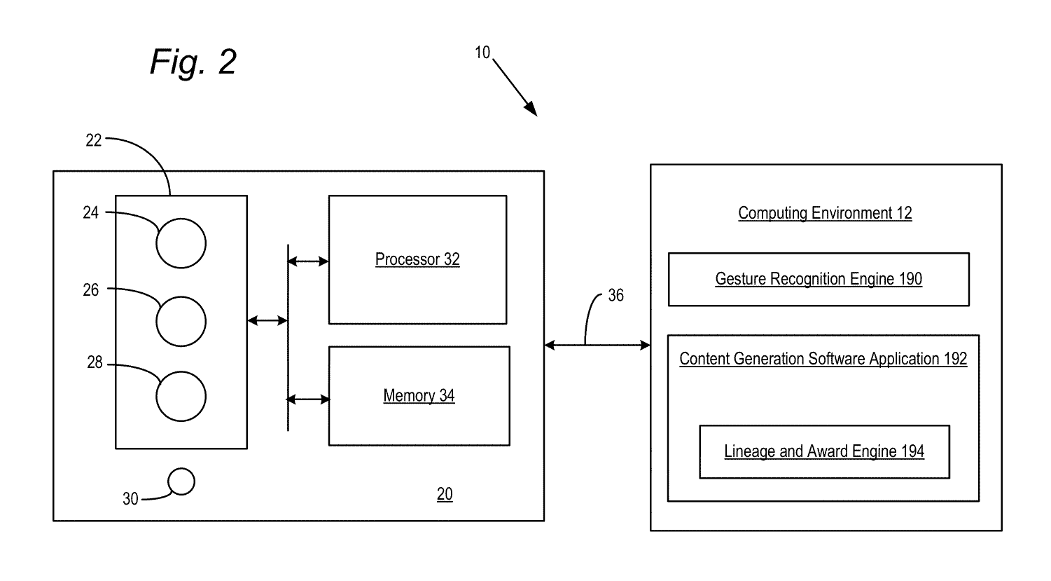

Referring initially to FIGS. 1-2, the hardware for implementing the present technology may include a target recognition, analysis, and tracking system 10 which may be used to recognize, analyze, and/or track a human target such as the user 18. Embodiments of the target recognition, analysis, and tracking system 10 include a computing environment 12 for executing a content generation software application or other application. The computing environment 12 may include hardware components and/or software components such that computing environment 12 may be used to execute applications such as the content generation software application. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to body and hand movements and/or gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis and tracking system 10 may be connected to an audio/visual (A/V) device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The A/V device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the A/V device 16 and the capture device 20 may cooperate to provide a NUI system where, for example, the user 18 is able to generate and modify a level 21, or remix a level 21 generated by another, that may be displayed on device 16. The level 21 illustrated is by way of example only, and as indicated above, a content generation software application may be used to generate a wide variety of different UGC in further embodiments. A secondary computing device 23 may be provided in addition to or instead of the computing environment 12 and capture device 20 to generate and modify a level 21, or remix a level 21 generated by another, that may be displayed on device 16.

The computing environment 12 may execute a content generation software application. Commands for generating the content of level 21 may be input by the user performing physical gestures and/or speak verbal instructions, which are interpreted by the system 10 as inputs to the content generation software application. Moreover, secondary computing device 23 may be paired with the system 10 such that the user may interact with the secondary computing device 23, for example using a keyboard and/or mouse pointing device, to provide input to the content generation software application to generate or aid in the generation of level 21.

Suitable examples of a system 10 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

FIG. 2 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight. X and Y axes may be defined as being perpendicular to the Z axis. The Y axis may be vertical and the X axis may be horizontal. Together, the X, Y and Z axes define the 3-D real world space captured by capture device 20.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as a content generation software application 192, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image camera component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28. With the aid of these devices, a partial skeletal model may be developed in accordance with the present technology, with the resulting data provided to the computing environment 12 via the communication link 36.

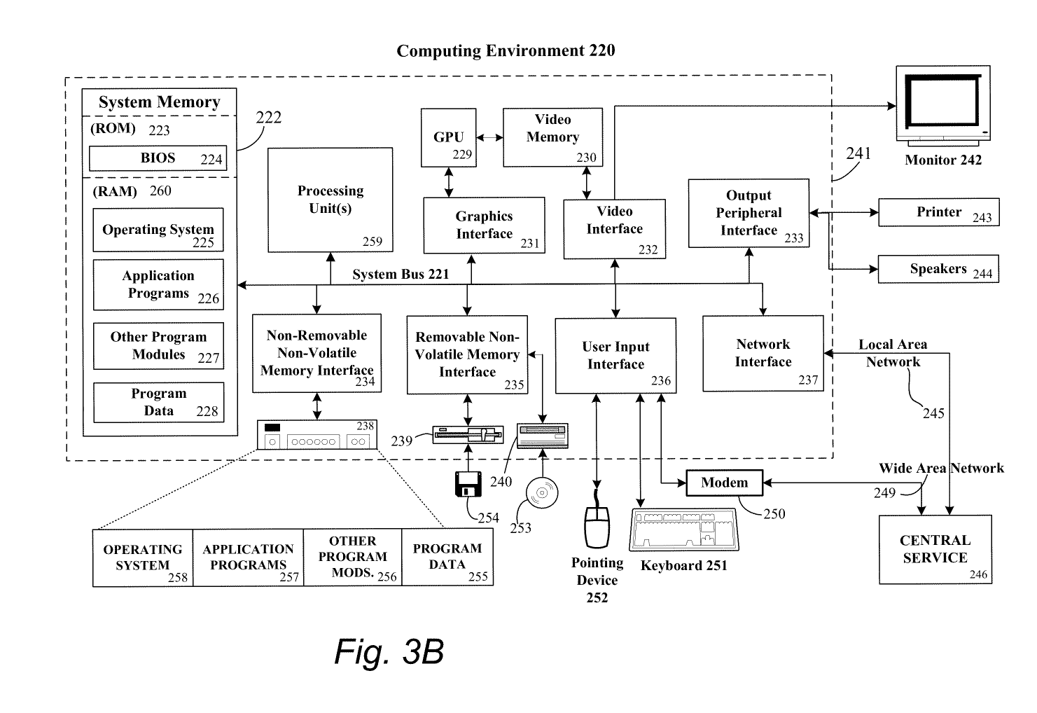

The computing environment 12 may further include a gesture recognition engine 190 for recognizing gestures, such as those providing input to the content generation software application 192. The content generation software application 192 may include a lineage and award engine 194, explained below, in accordance with the present technology. In further embodiments, the lineage and award engine 194 may exist independently of, but in communication with, the content generation software application 192. Moreover, in embodiments, the content generation software application 192 and/or lineage and award engine 194 may reside on a central service 246, explained hereinafter with respect to FIG. 4.

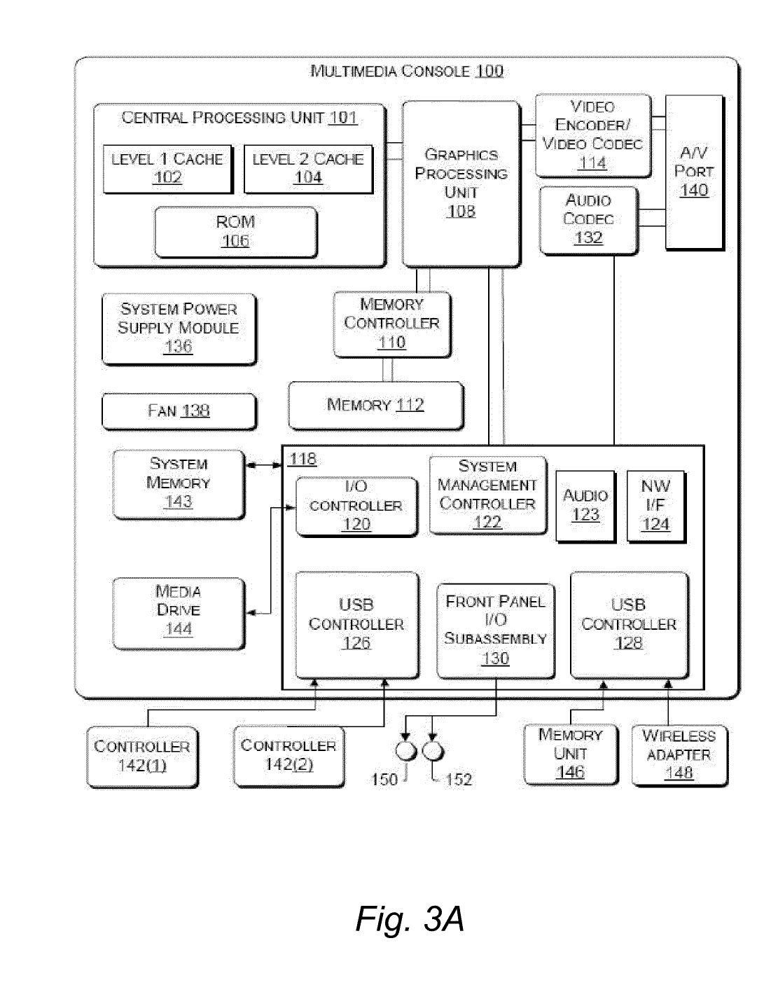

FIG. 3A illustrates an example embodiment of a computing environment that may be used to interpret one or more gestures in a target recognition, analysis, and tracking system. The computing environment such as the computing environment 12 described above with respect to FIGS. 1-2 may be a multimedia console 100, such as a gaming console. As shown in FIG. 3A, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application uses audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

FIG. 3B illustrates another example embodiment of a computing environment 220 that may be the computing environment 12 shown in FIGS. 1-2 used to interpret one or more gestures in a target recognition, analysis, and tracking system. The computing system environment 220 is one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 3B, the computing environment 220 comprises a computer 241, which typically includes a variety of computer readable media. Computer readable media can be any available tangible media that can be accessed by computer 241 and includes both volatile and nonvolatile media, removable and non-removable media. Computer readable media does not include transitory, modulated or other transmitted data signals that are not contained in a tangible media. The system memory 222 includes computer readable media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 3B illustrates operating system 225, application programs 226, other program modules 227, and program data 228.

The computer 241 may also include other removable/non-removable, volatile/nonvolatile computer storage media. By way of example only, FIG. 3B illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 3B, provide storage of computer readable instructions, data structures, program modules and other data for the computer 241. In FIG. 3B, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

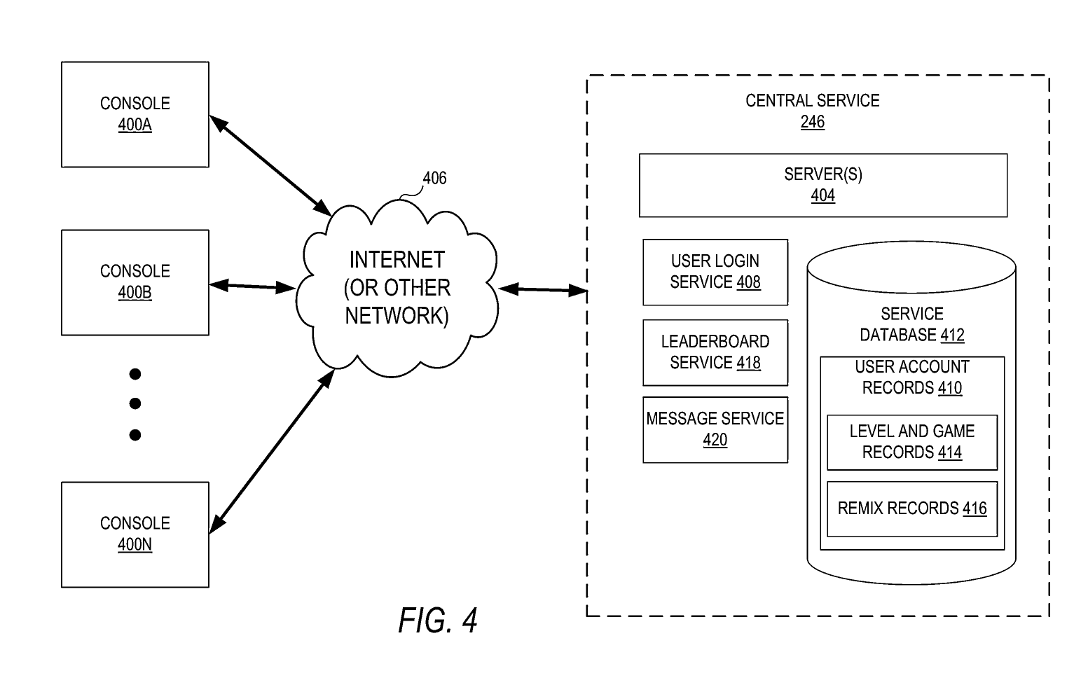

The computer 241 may operate in a networked environment using logical connections to one or more remote computers, such as those within a central service 246. Further details of central service 246 are described below with reference to FIG. 5. The logical connections depicted in FIG. 3B include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. It will be appreciated that the network connections shown are exemplary and other means of establishing a communications link between the computers may be used.

The computing environment 12 in conjunction with the capture device 20 may generate a computer model of a user's body position each frame. One example of such a pipeline which generates a skeletal model of one or more users in the field of view of capture device 20 is disclosed for example in U.S. patent application Ser. No. 12/876,418, entitled “System For Fast, Probabilistic Skeletal Tracking,” filed Sep. 7, 2010, which application is incorporated by reference herein in its entirety. Alternatively or additionally, the computing environment may determine which controls to perform in an application, such as the content generation software application executing on the computer environment based on, for example, gestures of the user that have been recognized from the skeletal model. For example, as shown, in FIG. 2, the computing environment 12 may include a gesture recognition engine 190. The gesture recognition engine 190 is explained hereinafter, but may in general include a collection of gesture filters, each comprising information concerning a gesture that may be performed by the skeletal model (as the user moves).

The data captured by the cameras 26, 28 and device 20 in the form of the skeletal model and movements associated with it may be compared to the gesture filters in the gesture recognition engine 190 to identify when a user (as represented by the skeletal model) has performed one or more gestures. Those gestures may be associated with various controls of an application. Thus, the computing environment 12 may use the gesture recognition engine 190 to interpret movements of the skeletal model and to control an application based on the movements. For example, in the context of the present disclosure, the gesture recognition engine may recognize when a user is performing a peer gesture to peer into the virtual distance of the scene displayed on display 14.

In accordance with the present technology, user generated levels may be created, uploaded to the central service 246 and stored. Thereafter, other users may access the stored levels, download them, and then they can play and experience those levels, as well as remix them. Where a user remixes a level, that remixed level may be uploaded to the central service 246 and stored. Thereafter, other users may access the original and/or remixed levels, download them, play and experience them, and remix them. As explained below, this process may be repeated to generate a tree having the original content at its root, and branches of remixed content.

FIG. 4 illustrates a system for sharing user generated content as described above. FIG. 4 provides a block diagram of multiple consoles 400A-400N networked with the central service 246 having one or more servers 404 through a network 406. In one embodiment, network 406 comprises the Internet, though other networks such as LAN or WAN are contemplated. Server(s) 404 include a communication component capable of receiving information from and transmitting information to consoles 400A-N and provide a collection of services that applications running on consoles 400A-N may invoke and utilize. The computing environment 12 and secondary computing system 23 described above may be any of the consoles 400A-N.

Consoles 400A-N may invoke user login service 408, which is used to authenticate a user on consoles 400A-N. During login, login service 408 obtains a gamer tag (a unique identifier associated with the user) and a password from the user as well as a console identifier that uniquely identifies the console that the user is using and a network path to the console. The gamer tag and password are authenticated by comparing them to user records 410 in a database 412, which may be located on the same server as user login service 408 or may be distributed on a different server or a collection of different servers. Once authenticated, user login service 408 stores the console identifier and the network path in user records 410 so that messages and information may be sent to the console.

User records 410 can include additional information about the user such as level and game records 414 and remix records 416. When a user creates a level, either as the content originator or a remixer of another's content, the data for that level may be stored in level and game records 414. Additionally, where a user plays within a level, state data associated with the user's progress, achievements and/or other game specific information may also be stored within level and game records 414. Remix records 416 may keep track where a user fits in the lineage of remixed content, e.g., those who remixed the content prior to the user, and those who remixed the content after the user. Each such user may be identified and linked to each other by an identifier that is created and stored in database 412 in association with an uploaded level. This feature is explained in greater detail below.

Portions of user records 410 can be stored on an individual console, in database 412 or on both. If an individual console retains level and game records 414 and/or remix records 416, this information can be provided to central service 246 through network 406. Additionally, the console has the ability to display information associated with the level and game records 414 and/or remix records 416 without having a connection to central service 246.

Server(s) 404 also include a mail message service 420 which permits one console, such as console 400A, to send a message to another console, such as console 400B. The message service 420 is known, the ability to compose and send messages from a console of a user is known, and the ability to receive and open messages at a console of a recipient is known. Mail messages can include emails, text messages, voice messages, attachments and specialized in-text messages known as invites, in which a user playing the game on one console invites a user on another console to play in the same game while using network 406 to pass gaming data between the two consoles so that the two users are playing from the same session of the game. Message service 420 may also be used to inform other users of created levels and invite them to experience and/or remix those levels. Service database may also keep a friends list (not shown) for each user, which can be used in conjunction with message service 420.

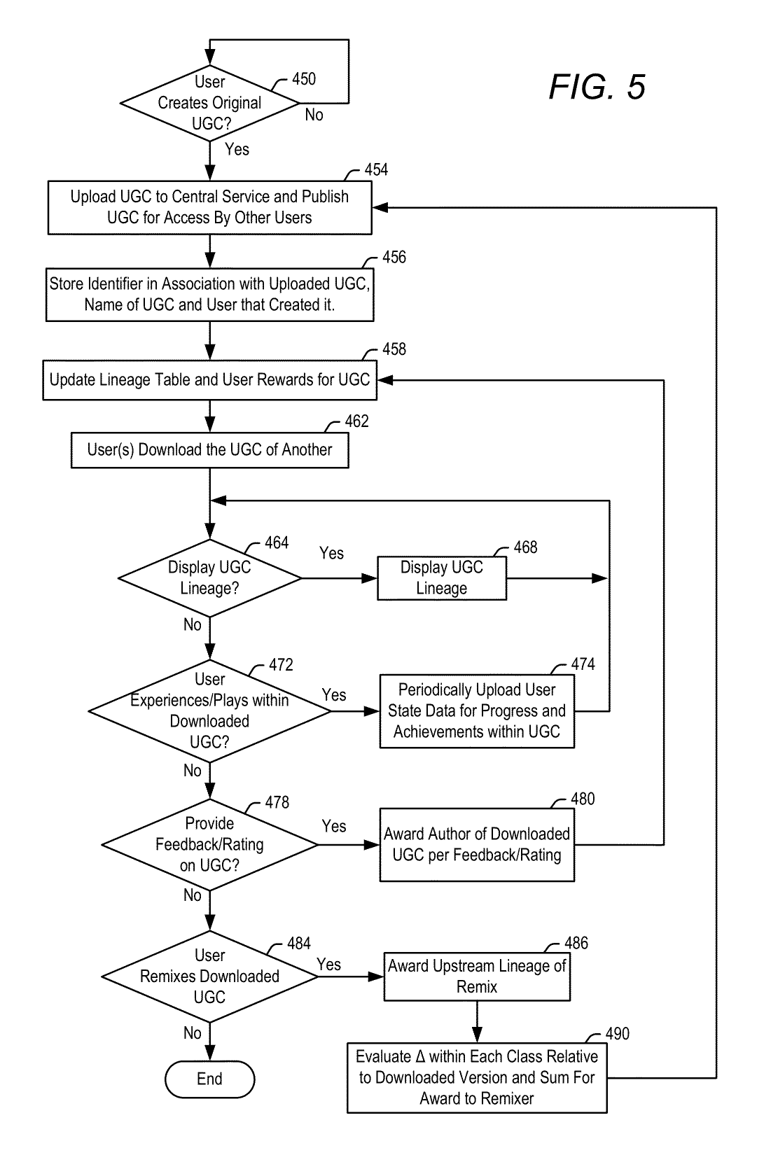

Operation of embodiments of the present technology will now be explained with reference to the flowchart of FIG. 5, and the illustrations of FIGS. 6-10. The steps shown in FIG. 5 may be performed by the content generation software application 192 and/or the lineage and award engine 194. Referring initially to the illustration of FIG. 6, there is shown one of a wide variety of remixing scenarios of levels or user generated content (UGC) in general. The example starts with the original creation of a piece of UGC. When that UGC is saved, it is saved together with a unique identifier. As explained below, that identifier is used to track the lineage of the original content, and all remixes of the original content.

In the example of FIG. 6, a user created the original content and it was assigned identifier ID0. Thereafter, four different users downloaded the original content, and remixed it to each create a new piece of UGC. These are referred to in FIG. 6 by their respective identifiers: ID1, ID2, ID4 and ID13. FIG. 6 has a temporal aspect so that remixes toward the left side of the drawing are created earlier in time than remixes toward the right side of the drawing. The time remixes are made need not be tracked in further embodiments.

Successive remixes of a given piece of content are denoted herein as being part of different generations. So direct remixes of the original content are referred to herein as first generation remixes. Direct remixes of any first generation remixes are referred to as second generation remixes. Direct remixes of any second generation remixes are referred to as third generation remixes. Etc. A piece of UGC that gets modified in a remix is referred to herein as a parent to that remix. In embodiments, the original content and all remixes remain accessible to users from the central service 246. Thus, for example ID12 (at the bottom of FIG. 6) may be a fourth generation remix of the original content, where ID13 may be a first generation remix of the content, even though the ID13 remix occurs later in time than the ID12 remix.

As shown, the various remixes may form a tree structure with different remixes being created in different branches. In the example shown the first generation remix ID4 has two second generation remixes—ID8 and ID9. ID9 has a third generation remix ID10, which in turn has a fourth generation remix ID14. The first generation remix ID2 has three second generation remixes—ID5, ID6 and ID3. ID3 has a third generation remix ID7, which has three remixes off of it—ID11, ID12 and ID15. Again, the example of FIG. 6 is for illustrative purposes only, and any of a wide variety branching remixes may occur. The remixes may be linear instead of branching in further embodiments. That is, each parent UGC has a single remix made therefrom (instead of multiple remixes in the same generation). Where two or more remixes are remixed from the same parent UGC, the resulting remixes may be similar or dissimilar to each other, depending on the type and degree of changes to the parent UGC that were made.

A user can download an existing UGC from the central service 246, and make changes to it using the same content generation software application and software tools that were used to create the parent UGC. In further embodiments, changes to a UGC may be made in a remix using a different content generation software application and/or software tools than those used for the parent UGC.

A remix may be any modification to a prior version of the UGC. As noted above, in embodiment, a user has different classes of software tools in the content generation software application which they can use to modify UGC available from central service 246. In embodiments, these tools include an artist software tool, a designer software tool and a programmer software tool. A remix may be created and saved by making a change using any one or more of these software tools. In further embodiments, one or more of these software tool classes may be combined, omitted, or augmented by additional software tools. Moreover, the functionality of these respective software tools may be classified differently or referred to with names other than artist tools, designer tools and/or programmer tools. In any of these embodiments, using any tools available to the content generation software application, a user may make a change to an existing piece of UGC, and save that new version as a remix, which is assigned a new identifier.

In embodiments, a user who remixes a piece of content is a different user than the one who created the parent of that remix. Where a user alters his or her own saved content, the user may simply repost that content and it would not be a remix. However, it is conceivable that a user remix his or her own parent UGC. It is also conceivable that a user remix his or her own UGC from a generation earlier than the parent UGC (e.g., a first user posts a UGC, a second user remixes that UGC, and then the first user remixes that remix). In embodiments, where a user remixes his or her own UGC, that remix does not result in awards (for either the remix or the content that was remixed). Awards in accord with the present technology are explained hereinafter. It is also conceivable that the same user create two different remixes (e.g., ID11 and ID12) off the same parent UGC (e.g., ID7).

Referring now to the flowchart of FIG. 5, in step 450, a user may create an original level as described above, or other original user generated content (UGC), using a console 400. In step 454, the UGC may be uploaded to the central service 246 and stored on service database 412 so that is accessible to other users. In an alternative embodiment, portions or all of the content generation software application may be resident within the central service 246 instead of on a console 400. In such embodiments, a user may access central service 246 via a web server (one of servers 404), and generate UGC directly within the central service 246, which is then stored in the service database 412.

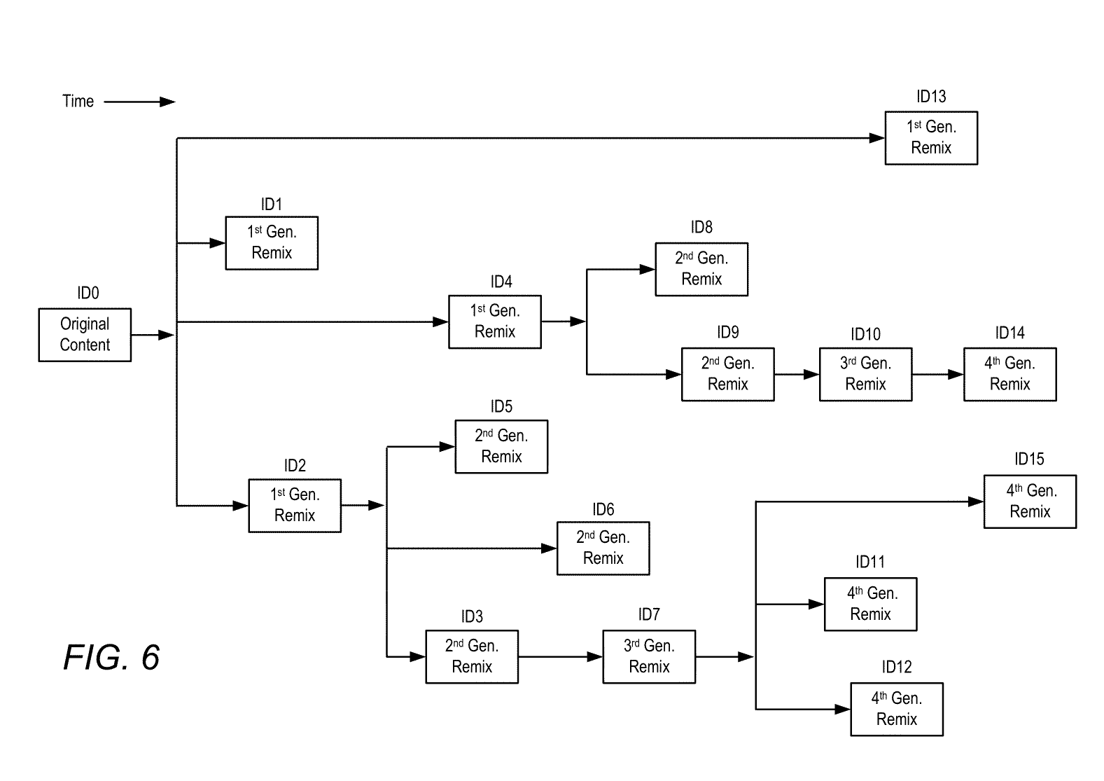

A unique identifier, described above, is generated and stored in step 456 in association with the uploaded UGC, a name of the UGC and the user that created it. In step 458, the content generation software application may update a lineage table and user rewards for the UGC. The user rewards are explained hereinafter. An example of a lineage table 492 is shown in FIG. 7. The lineage table is based on the remixes that occurred in the example of FIG. 6. It is understood that the lineage table of FIG. 7 would be different where the remixes are different in FIG. 6. The original UGC is assigned a first identifier 494 (e.g., ID0). As explained above, each successive remix is assigned an identifier 494 in step 456, and is linked to the identifier 494 of its parent UGC in the lineage table in step 458. The lineage table 492 which may be stored as a look-up table in service database 412, includes a parent UGC in the second column, and all remixes from that parent in the third column.

Thus, the original UGC (ID0) has four first generation remixes—ID1, ID2, ID4 and ID13. Of those four, ID2 and ID4 have second generation remixes—ID3, ID5 and ID6 are remixes of ID 2, and ID8 and ID9 are remixes of ID4. ID3 has a third generation remix ID7, and ID7 has three fourth generation remixes ID11, ID12 and ID15. ID9 has a third generation remix, ID10, which in turn has a fourth generation remix, ID 14.

Using the lineage table 492, any chain of remixes may be established from any given remix back to the original content by starting with the identifier of the given remix in the third column and getting its parent from the second column of the same row. That parent is then found in the third column from the next earlier generation in a higher row, and its parent is in turn found from the second column. This process may be repeated until a remix ID in third column has the original content as its parent in the second column. Thus, the lineage table 492 sets forth a complete chain of remixes for a given piece of UGC, from the content originator to the last remix made of the UGC.

Referring again to the flowchart of FIG. 5, a user may download UGC the user is interested in from the central service 246 in step 462. The user may choose from a list of available UGC, a description of available UGC and/or thumbnails of available UGC. Once downloaded, a user to perform a variety of actions with respect to downloaded UGC, some of which are set forth in the flowchart of FIG. 5. It is understood that a user may have the option to perform a variety other actions with respect to downloaded UGC in addition to or instead of those shown in FIG. 5.

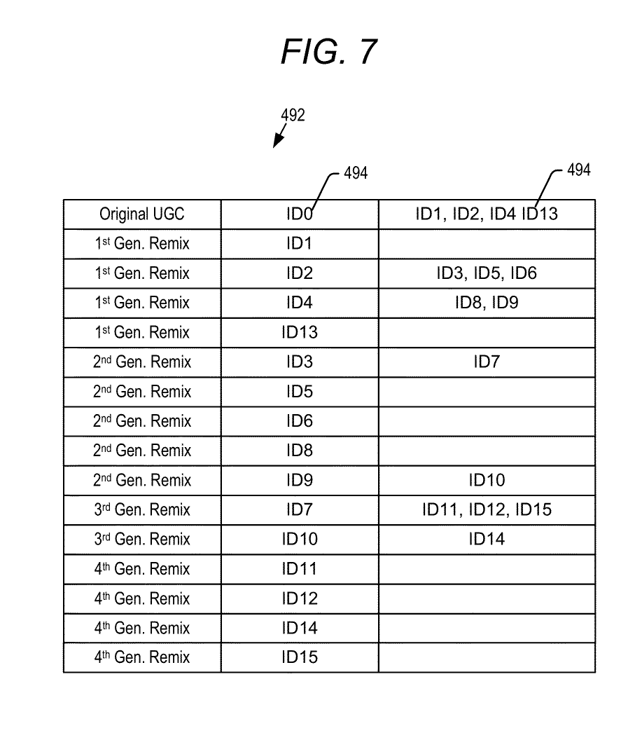

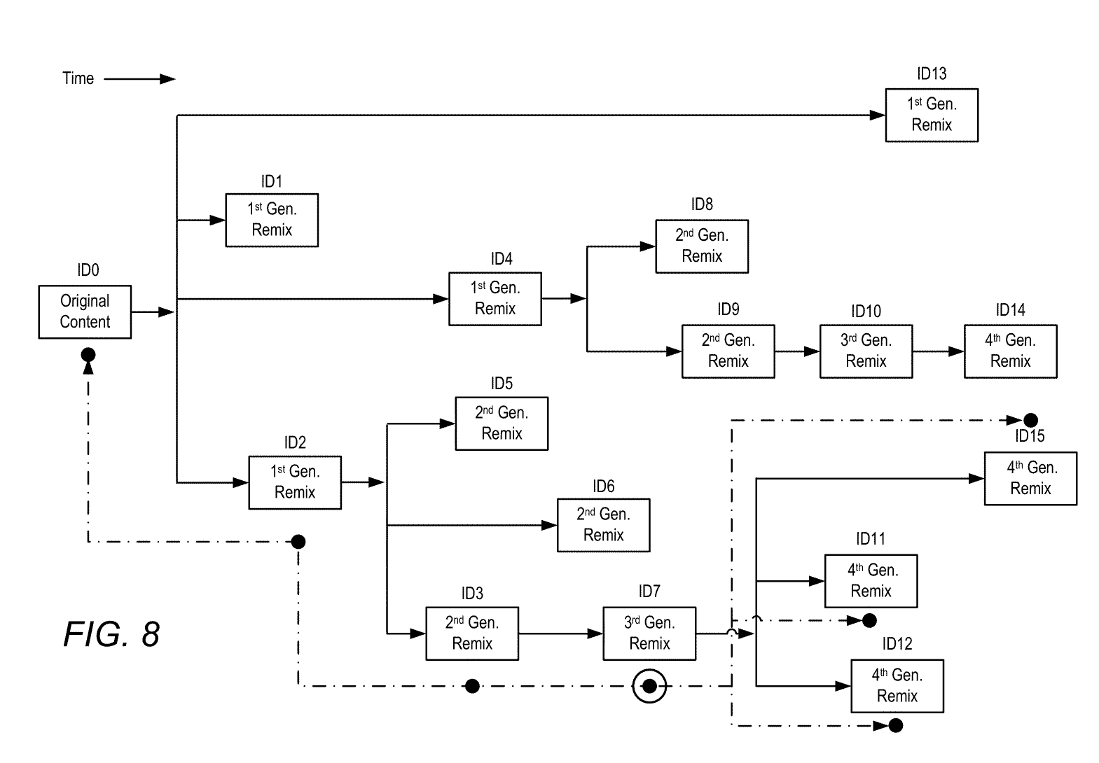

One aspect of the present technology is track and reward users in the lineage of a given piece of content as it evolves through different remixes. This tracking may be performed by the lineage and award engine 194. One option a user has is to view the lineage of UGC in step 464. One example will now be described with reference to FIGS. 8 and 9. In this example, a user has chosen to download the remix associated with identifier ID7. As indicated by the dashed arrows in FIG. 8, remix ID7 has both upstream parent UGC and downstream children UGC. These parents and children for remix ID7 are illustrated in table 496 in FIG. 9. The table of FIG. 9 also shows sample names of the users who created the remixes associated with the identifiers, and the names given the UGC by the users who created the remixes. These names may be stored in association with the lineage table 492. The names shown are by way of example only.

If the user elects to view the lineage of the remix ID7 in step 464, the lineage may be displayed to the user in step 468 from the lineage table 492 of FIG. 7 (as summarized for this example in table 496 of FIG. 9). In particular, a user may be shown a word-based display including the names associated with remixes in the past lineage (upstream) and future lineage (remixes that were made off of the UGC that the user is then viewing). For example, the user viewing “Robber Caves” may be shown the following in step 468:
Your Level: “Robber Caves” by Astrogal65
Astrogal65 remixed from “Caves” by Shrekkerman,
Who remixed from “Willow Caves” by Mr. B,
Who remixed from “Willow” by Rader, the content originator.
Robber Caves was remixed by:
   Wizard Keep by JackMar
   Robber Hideout by Marlee22
   Battle Ground by Mr. Samuel
      Each of these may be displayed as a hyperlink in examples so that a user may access those levels by simply clicking on them. It is understood that the past and future lineage of a given UGC may be displayed to a user in words using a wide variety of other formats in further embodiments. As explained below, each remix may have rewards that have been given to the UGC. This may also be displayed to the user in step 468.

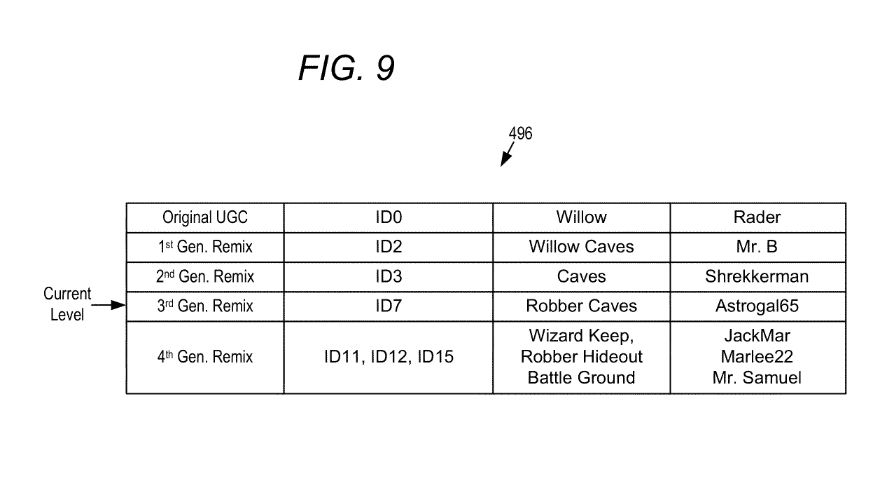

FIG. 10 illustrates a screenshot for displaying the lineage of the above example graphically. While viewing UGC (e.g., remix ID7, named “Robber Caves” in this example), the user may select a graphical button for 440 to bring up the lineage view in step 464. At that point, the current UGC may be displayed in a center panel, its parent displayed in a panel to the left, and remixes of the current UGC may be displayed in a panel to the right.

The user may have the option to scroll the panels left and right to see others in the lineage. In this example, the user would have the option of scrolling the panels to the right to see any further parents (e.g., “Willow Caves” by Mr. B, and “Willow” by Rader, the content originator in this example). Upon a first scroll to the right, a graphic for “Caves” would move to the center, a graphic for “Willow Caves” would appear in the left panel, and “Robber Caves” can be shown in the Remix panel to the right. Alternatively, a user could scroll to the left from the view shown in FIG. 10 to move to focus on one or more of the remixes shown in the right panel in FIG. 10. The user may further have the option of accessing UGC in any of the display panels by selecting a panel. It is understood that the past and future lineage of a given UGC may be displayed to a user with graphics using a wide variety of other formats and appearances in further embodiments.

Referring again to the flowchart of FIG. 5, instead of displaying UGC lineage in step 464, a user may instead simply experience downloaded UGC in step 472. This may include for example playing a game, where the UGC is a level or fantasy world presenting a gaming situation. If the user elects to experience/play the downloaded UGC, the UGC or other application may periodically upload user state data in step 474 for progress and achievements within the UGC to central service 246.

When experiencing/playing within a downloaded level or other UGC, a user may wish to provide feedback or a rating with respect to that UGC. In step 478, a user is given the option to provide such feedback and/or rating. This information may be stored on the central service 246 and used by the lineage and award engine 194. For feedback, a user may be given the option to add textual comments, which comments may then be uploaded and saved in central service 246. Alternatively, a user may be given the option to rate UGC, for example giving it a maximum of five stars (or a higher maximum) when the user very much likes the UGC, or less stars when the user does not like it as much. Other rating scales may be used, such as for example giving it a rating of 1 through 10 or 1 through 100. The rating may also then be uploaded and saved in central service 246.

In step 480, feedback and/or a rating for a given piece of UGC may be used by the lineage and award engine 194 to generate a reward for the creator of that UGC. For example, referring again to the UGC lineage map shown on FIG. 10, a star rating 442 is shown beneath the name of each of the levels shown. This rating comes from one or more users in step 480 (the rating from each of the users may be averaged together to provide the ratings shown in FIG. 10). Another menu option (not shown) may be provided on each of the panels shown in FIG. 10 which, when selected, may display the textual feedback provided from one or more users for that level.

Referring again to the flowchart of FIG. 5, in step 484 a user may elect to remix UGC that they have downloaded. As explained above, a user may modify downloaded UGC using a content generated software application and a user interface such as for example the system 10 shown in FIG. 1 to create a remix of the UGC.

In accordance with aspects of the present technology, the creators of content are motivated to have others remix their content. In particular, the lineage and award engine 194 may award creators of content when their content is remixed. In step 486, when a parent UGC is remixed, the user that created the parent UGC is awarded some predefined reward. This may for example be a predefined number of points or some other virtual currency. In further embodiments, creators of content upstream of the parent may also get some predefined award (which may be the same as or different from the reward to the parent UGC). Thus, when a user remixes a piece of UGC, all users in the lineage chain back to the original content creator may receive a reward. In alternative embodiments, it may just be the parent that receives the reward.

In accordance with further aspects of the present technology, users are not just allowed to remix others' UGC, but they are encouraged by an award system to contribute to others' UGC. In embodiments, this is done by the lineage and award engine 194 measuring the degree to which a user has made changes to a parent UGC, and awarding the remix user accordingly in step 490. Thus, where a user makes substantial modifications to a parent UGC, that user will receive a larger award then another user who makes minor modifications to that parent UGC.

In order to award remixers in this manner, in step 490, the present system evaluates the delta (Δ) of the remix relative to the parent UGC. As noted above, content generation in an embodiment of the present technology may be broken down into different classes, such as for example an artist class, a designer class and a programmer class. Each one of these classes may have its own predefined metric for measuring Δ. For example, in the artist class, the system may measure the total voxel change (measuring both additions and subtractions) of the remix relative to the parent UGC and assign a reward based on the Δ. In the designer class, the system may measure the total number of new objects added to the remix relative to the parent UGC and assign a reward based on the Δ. In the programmer class, the system may measure how much behavior and intelligence was added to each of the characters and/or objects within the remix, and how much more developed and complex the achievements, objectives, conflicts and game metrics are. This addition may be assigned a reward based on the Δ as compared to the parent UGC.

The above is by way of example only and the various changes to the various classes may be quantified by a variety of different metrics to arrive at a Δ within each class. These Δs may then be summed and the total Δ may be converted into a reward to the remixer. That reward may for example be a predefined number of points or some other virtual currency.

Alternatively or additionally, the reward may be a title which is assigned to the user, and possibly displayed on the linage map together with the user's name. For example, a remixer may be given the title of “Junior Remixer,” “Senior Remixer,” or “Lead Remixer,” which title may be displayed under the user's displayed name. These titles are by way of example only and a wide variety of other titles may be awarded which indicate the degree of achievement relative to each other. Titles may be earned based on an award for a single remix, or based on the awards for all of a given user's remixes. Titles may alternatively be earned from awards to the specific classes, such as “Junior Artist,” “Senior Artist,” or “Lead Artist,” or “Junior Programmer,” “Senior Programmer,” or “Lead Programmer” In such an example, a given user may have different titles for different classes.

The lineage and award engine 194 may further award remixers a bonus based on user ratings of the remix and the parent of the remix. In one such example, a creator (or subsequent remixer) may create/modify UGC, and the community rates that content as described above. When the next remix is done, the community may rate that remix. The lineage and award engine 194 may calculate a difference in ratings between the parent and the remix, and may award a bonus to the remixer if the remix's rating is an improvement over the parent. The amount of the bonus may be based on the amount of the difference in ratings between the parent and the remix. If the remixer has not received a higher rating than the parent, then a bonus may not be awarded. In an alternative embodiment, in addition to possibly receiving a bonus, it is conceivable that a remixer may lose points or otherwise be penalized if the rating on the remix is lower than the rating on the parent UGC. In embodiments, when a remixer creates a remix so as to earn a bonus (or not, depending on the respective ratings), there is no impact on the parent's award for their work being remixed.

After a user has remixed a piece of UGC in step 484, and awards have been given to the parent and the remixer in steps 486 and 490, the flow may return to step 454, where the remix is uploaded to the central service 246 and published so that others can now access and view the remix. The identifier for the remix may be stored in step 456. The lineage table (FIG. 7) may be updated to include the remix, and awards for the remix and parent of the remix may be updated in step 458. The steps shown in FIG. 5 may be performed for a variety of users, accessing and remixing a variety of different UGC, to create a wide variety of different tree structures, such as that shown in FIG. 6.

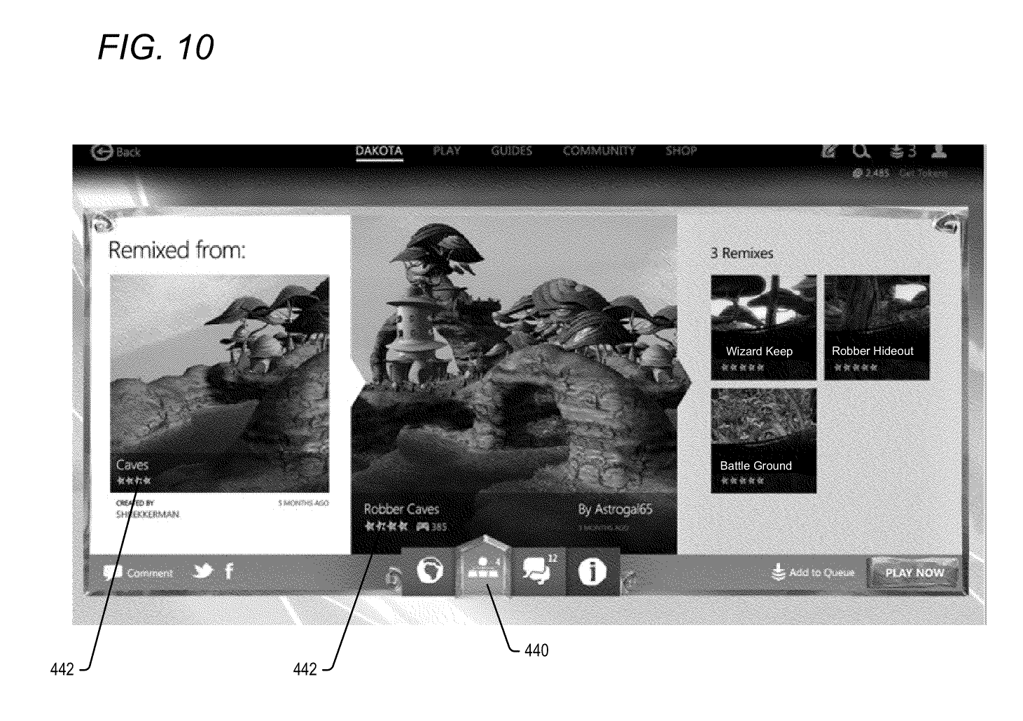

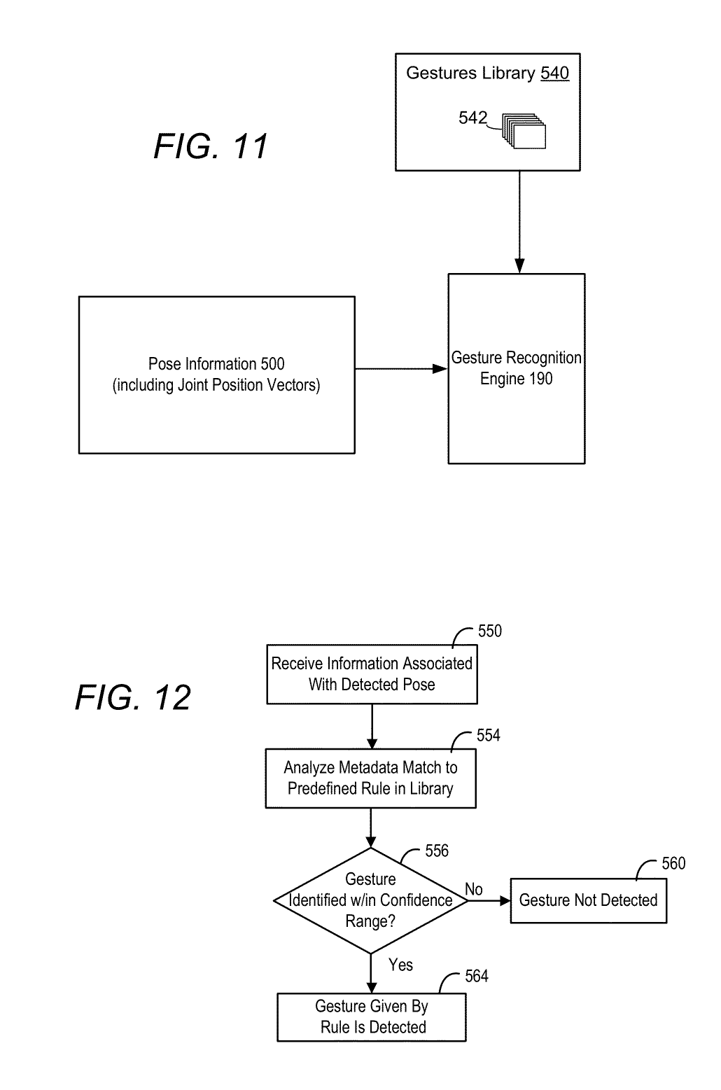

As noted above, in one embodiment, a user may interact with the content generation software application 192 using a natural user interface that detects and interprets user gestures via a gesture recognition engine 190. One embodiment of the gesture recognition engine 190 for recognizing predefined gestures will now be explained with reference to FIGS. 11 and 12. Those of skill in the art will understand a variety of methods of analyzing user body movements and position to determine whether the movements/position conform to a predefined gesture. Such methods are disclosed for example in the above incorporated application Ser. No. 12/475,308, as well as U.S. Patent Application Publication No. 2009/0074248, entitled “Gesture-Controlled Interfaces For Self-Service Machines And Other Applications,” which publication is incorporated by reference herein in its entirety. However, in general, user positions and movements are detected by the capture device 20. From this data, joint position vectors may be determined. The joint position vectors may then passed to the gesture recognition engine 190, together with other pose information. The operation of gesture recognition engine 190 is explained in greater detail with reference to the block diagram of FIG. 11 and the flowchart of FIG. 12.

The gesture recognition engine 190 receives pose information 500 in step 550. The pose information may include a great many parameters in addition to joint position vectors. Such additional parameters may include the x, y and z minimum and maximum image plane positions detected by the capture device 20. The parameters may also include a measurement on a per-joint basis of the velocity and acceleration for discrete time intervals. Thus, in embodiments, the gesture recognition engine 190 can receive a full picture of the position and kinetic activity of all points in the user's body.

The gesture recognition engine 190 analyzes the received pose information 500 in step 554 to see if the pose information matches any predefined rule 542 stored within a gestures library 540. A stored rule 542 describes when particular positions and/or kinetic motions indicated by the pose information 500 are to be interpreted as a predefined gesture. In embodiments, each gesture may have a different, unique rule or set of rules 542. Each rule may have a number of parameters (joint position vectors, maximum/minimum position, change in position, etc.) for one or more of the body parts of a user's body. A stored rule may define, for each parameter and for each body part, a single value, a range of values, a maximum value, a minimum value or an indication that a parameter for that body part is not relevant to the determination of the gesture covered by the rule. Rules may be created by a game author, by a host of the gaming platform or by users themselves.

The gesture recognition engine 190 may output both an identified gesture and a confidence level which corresponds to the likelihood that the user's position/movement corresponds to that gesture. In particular, in addition to defining the parameters for a gesture, a rule may further include a threshold confidence level to be achieved before pose information 500 is to be interpreted as a gesture. Some gestures may have more impact as system commands or gaming instructions, and as such, have a higher confidence level before a pose is interpreted as that gesture. The comparison of the pose information against the stored parameters for a rule results in a cumulative confidence level as to whether the pose information indicates a gesture.

Once a confidence level has been determined as to whether a given pose or motion satisfies a given gesture rule, the gesture recognition engine 190 then determines in step 556 whether the confidence level is above a predetermined threshold for the rule under consideration. The threshold confidence level may be stored in association with the rule under consideration. If the confidence level is below the threshold, no gesture is detected (step 560) and no action is taken. On the other hand, if the confidence level is above the threshold, the user's motion is determined to satisfy the gesture rule under consideration, and the gesture recognition engine 190 returns the identified gesture.

Given the above disclosure, it will be appreciated that a great many gestures may be identified using joint position vectors in addition to the peer gesture. As one of many examples, the user may lift and drop each leg 312-320 to mimic walking without moving.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method for tracking modifications to user generated content, comprising:
(a) storing original user generated content, the original user generated content generated with a computing device executing a content generation software application;
(b) storing a first identifier associated with the original user generated content;
(c) providing access to the original user generated content so as to allow remixing of the original user generated content;
(d) storing a remix of the original user generated content, the remix generated with a computing device executing a content generation software application;
(e) storing a second identifier associated with the remix; and
(f) linking the first and second identifiers to enable identification of the remix while the original user generated content is accessed, and to enable identification of the original user generated content while the remix is accessed.

2. The method of claim 1, wherein the remix comprises a first generation remix, the method further comprising:
(g) providing access to the first generation remix;
(h) storing a second generation remix of the first generation remix, the second generation remix generated with a computing device executing a content generation software application;
(i) storing a third identifier associated with the second generation remix; and
(j) linking the second and third identifiers to enable identification of the first and second generation remixes while the original user generated content is accessed, to enable identification of the original user generated content and second generation remix while the second generation remix is accessed, and to enable identification of the original user generated content and the first generation remix while the second generation remix is accessed.

3. The method of claim 2, further comprising the step of allowing access to the original user generated content and the third generation remix from the second generation remix.

4. The method of claim 2, further comprising the step of providing a word-based lineage for display, the word-based lineage describing in words the relationship between the original user generated content, the first generation remix and the second generation remix.

5. The method of claim 2, further comprising the step of providing a graphical lineage for display, the graphical lineage graphically showing the relationship between the original user generated content, the first generation remix and the second generation remix.

6. The method of claim 1, further comprising the step of awarding a creator of the original user generated content upon storing the remix in said step (d).

7. The method of claim 1, further comprising the step of awarding a creator of the remix upon storing the remix in said step (d).

8. The method of claim 5, said step of awarding the creator of the remix comprising the step of awarding the creator of the remix commensurate with the degree to which the remix alters the original user generated content.

9. A computer readable media for programming a processor to perform a method for tracking modifications to user generated content, comprising:
(a) storing original user generated content, the original user generated content generated with a computing device executing a content generation software application;
(b) storing a first identifier associated with the original user generated content;
(c) providing access to the original user generated content so as to allow remixing of the original user generated content;
(d) storing a remix of the original user generated content, the remix generated with a computing device executing a content generation software application;
(e) storing a second identifier associated with the remix;
(f) rewarding a creator of the remix for modifying the original user generated content; and
(g) rewarding a creator of the original user generated content upon storing the remix of the user generated content.

10. The computer readable media of claim 9, wherein said step (f) comprises the step of awarding the creator of the remix commensurate with the degree to which the remix differs from the original user generated content.

11. The computer readable media of claim 9, wherein said step (f) comprises the steps of determining changes that have been made in the remix relative to the original user generated content, quantifying the changes that have been made, and rewarding the creator of the remix based on the quantified changes that have been made.

12. The computer readable media of claim 9, wherein said step (d) comprises storing the remix where changes in two more different classes of content generation have been made relative to the original user generated content.

13. The computer readable media of claim 12, wherein said step (f) comprises the step of determining changes that have been made in the two or more different classes of content generation in the remix relative to the original user generated content, quantifying the changes that have been made in the two or more different classes, summing the quantified changes from the two or more different classes, and rewarding the creator of the remix based on the summed, quantified changes that have been made.

14. The computer readable media of claim 9, wherein the remix comprises a first generation remix, the method further comprising the steps of:
(h) providing access to the first generation remix so as to allow remixing of the first generation remix;
(i) storing a second generation remix of the first generation remix, the second generation remix generated with a computing device executing a content generation software application;
(j) storing a third identifier associated with the second generation remix;
(k) rewarding a creator of the first generation remix upon storing the second generation remix; and
(m) rewarding a creator of the original user generated content upon storing the second generation remix.

15. A system for tracking modifications to a level of a virtual fantasy environment, comprising:
a content generation software application for generating the level and generating one or more remixes of the level and other remixes;
one or more natural user interfaces for interpreting audible and physical gestures as input to the content generation software application to generate the level and the one or more remixes of the level and other remixes;
a central service for storing and publishing the level and the one or more remixes of the level and other remixes; and
a lineage and award engine for linking the level and one or more remixes of the level and other remixes to allow identification of a lineage of remixes that were made from the level and other remixes, and for awarding creators of content whose content gets remixed.

16. The system of claim 15, wherein the lineage and award engine awards a creator of a remix.

17. The system of claim 16, wherein the lineage and award engine awards a creator of a parent of a remix.

18. The system of claim 16, wherein the lineage and award engine awards all creators in a lineage of a remix from the parent of the remix back to an original creator of the level.

19. The system of claim 14, wherein the lineage and award engine stores a table showing all branches of remixes from an original creation of the level, and the lineage from a remix back to an original creator of the level.

20. The system of claim 19, wherein the table is used to display a past and future lineage of a remix that has been downloaded from the central service.
